(19) United States
(12) Patent Application Publication
(10) Pub. No.: US 2024/0056720 A1
(43) Pub. Date: Feb. 15, 2024

(54) METHOD FOR OUTPUTTING AUDIO SIGNAL, AND ELECTRONIC DEVICE FOR PERFORMING SAME

(71) Applicant: Samsung Electronics Co., Ltd., Suwon-si (KR)

(72) Inventors: Juyeon JIN, Suwon-si (KR); Gupil CHEONG, Suwon-si (KR); Doosuk KANG, Suwon-si (KR); Bokun CHOI, Suwon-si (KR)

(21) Appl. No.: 18/495,273

(22) Filed: Oct. 26, 2023

Related U.S. Application Data
(63) Continuation of application No. PCT/KR2022/004031, filed on Mar. 23, 2022.

(30) Foreign Application Priority Data
Apr. 27, 2021 (KR) 10-2021-0054121

(51) Int. Cl. H04R 1/10

(52) U.S. Cl. CPC H04R 1/1041; H04R 1/1091; H04R 2420/07; H04R 2201/10

(57) ABSTRACT

An electronic device is provided. The electronic device includes a display module, a communication module for exchanging data with an external device, and at least one processor which is connected to the display module and the communication module and which controls the electronic device, wherein the at least one processor is configured to receive information about a first audio source device through the communication module, output the received information about the first audio source device through a display of the display module, receive a first audio broadcast stream transmitted by the first audio source device if the first audio source device is selected by a user, and transmit, to an audio output device, a first audio signal of the first audio broadcast stream through a wireless link established with the audio output device through the communication module, and the first audio signal can be output through the audio output device.

### CROSS-REFERENCE TO RELATED APPLICATION(S)

This application is a continuation application, claiming priority under § 365(c), of an International application No. PCT/KR2022/004031, filed on Mar. 23, 2022, which is based on and claims the benefit of a Korean patent application number 10-2021-0054121, filed on Apr. 27, 2021, in the Korean Intellectual Property Office, the disclosure of which is incorporated by reference herein in its entirety.

### BACKGROUND

### 1. Field

The disclosure relates to an electronic device for outputting an audio signal.

### 2. Description of Related Art

An electronic device supporting Bluetooth legacy may search for an audio source device by scanning and may output an audio signal provided by an audio source by pairing with the audio source device. For example, when a smartphone that is able to serve as an audio source device is paired with wireless earphones and an audio signal is generated through a music application of the smartphone, the audio signal may be output through the wireless earphones.

The above information is presented as background information only to assist with an understanding of the disclosure. No determination has been made, and no assertion is made, as to whether any of the above might be applicable as prior art with regard to the disclosure.

### SUMMARY

When a user desires to listen to music by connecting an electronic device that is not a smartphone to wireless earphones, the user may need to pair the wireless earphones with the electronic device. To pair the wireless earphones with the electronic device, existing pairing with the smartphone may need to be canceled.

Aspects of the disclosure are to address at least the above-mentioned problems and/or disadvantages and to provide at least the advantages described below. Accordingly, an aspect of the disclosure is to provide an electronic device outputting an audio signal through an external device connected to the electronic device based on information received from an audio source.

Additional aspects will be set forth in part in the description which follows and, in part, will be apparent from the description, or may be learned by practice of the presented embodiments.

According to various embodiments, an electronic device is provided. The electronic device includes a display module, a communication module configured to exchange data with an external device, and at least one processor connected to the display module and the communication module, wherein the at least one processor is configured to receive information of a first audio source device through the communication module, output the received information of the first audio source device through a display of the display module, when a user selects the first audio source device, receive first audio broadcast stream transmitted by the first audio source device, transmit a first audio signal of the first audio broadcast stream to the audio output device through wireless link established with the audio output device through the communication module, and cause the first audio signal to be output through the audio output device.

According to various embodiments, a method of outputting an audio signal, performed by an electronic device is provided. The method includes receiving information of a first audio source device through a communication module, outputting the received information of the first audio source device through a display of a display module, when a user selects the first audio source device, receiving first audio broadcast stream transmitted by the first audio source device, causing a first audio signal to be output by the audio output device by transmitting the first audio signal of the first audio broadcast stream to the audio output device through wireless link established with the audio output device through the communication module.

According to various embodiments, an audio output device is provided. The audio output device includes a communication module configured to exchange data with an external device, and at least one processor connected to the communication module, wherein the at least one processor is configured to receive information of a first audio source device through the communication module, transmit information of the first audio source device to an electronic device through wireless link established with the electronic device through the communication module, when the first audio source device is selected by the electronic device, receive first audio broadcast stream transmitted by the first audio source device, and output a first audio signal of the first audio broadcast stream.

According to one embodiment, an electronic device outputting an audio signal through an external device connected to the electronic device based on information received from an audio source may be provided.

Other embodiments, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other embodiments, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module according to an embodiment of the disclosure;

FIG. 3 is a diagram of an audio signal output system according to an embodiment of the disclosure;

FIG. 4 is a flowchart illustrating a method, performed by an electronic device, of outputting an audio signal according to an embodiment of the disclosure;

FIGS. 5A, 5B, and 5C are diagrams illustrating a wireless link established between an electronic device and an audio output device according to various embodiments of the disclosure;

FIG. 6 is a flowchart illustrating a method of receiving information of an audio source device according to an embodiment of the disclosure;

FIG. 7 is a flowchart illustrating a method of receiving information of an audio source device from an audio output device according to an embodiment of the disclosure;

FIG. 8 is a flowchart illustrating a method of outputting information of an audio source device according to an embodiment of the disclosure;

FIG. 9 illustrates a list generated to show, through user experience (UX) of an electronic device, a plurality of audio source devices detected by scanning according to an embodiment of the disclosure;

FIG. 10 is a flowchart illustrating a method of outputting additional information based on audio broadcast stream according to an embodiment of the disclosure;

FIG. 11 is a flowchart illustrating a method of an electronic device to control an audio output device to receive audio broadcast stream according to an embodiment of the disclosure;

FIG. 12 is a flowchart illustrating a method, performed by an audio output device, of outputting an audio signal according to an embodiment of the disclosure;

FIG. 13 is a flowchart illustrating a method of receiving information of an audio source device according to an embodiment of the disclosure;

FIG. 14 is a flowchart illustrating a method of outputting a mixed audio signal according to an embodiment of the disclosure; and

FIG. 15 is a flowchart illustrating a method of an audio output device to control an electronic device to receive audio broadcast stream according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

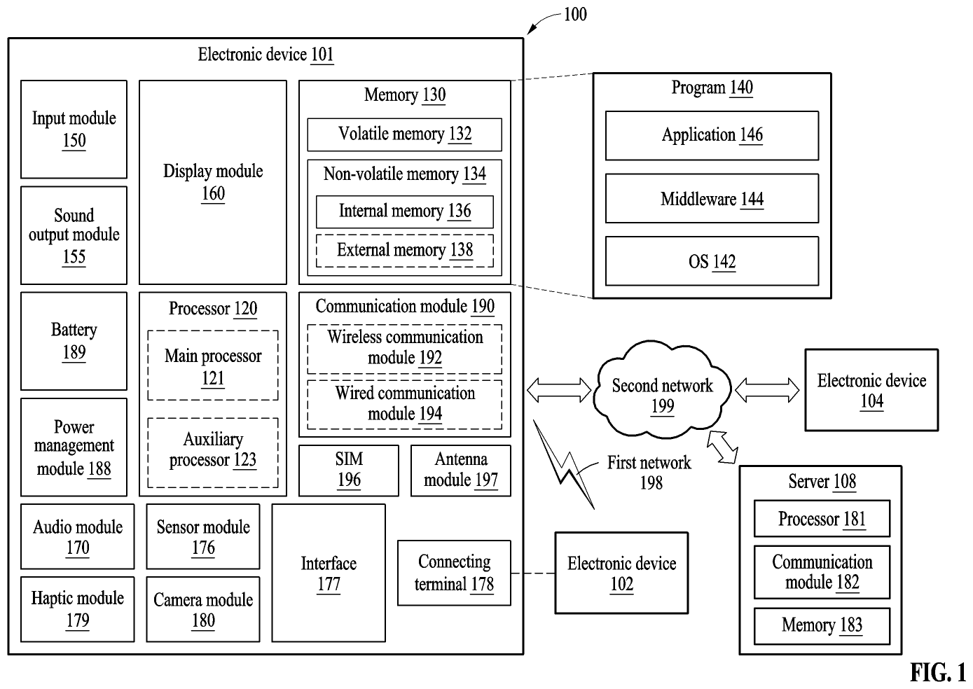

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to one embodiment, the electronic device 101 may communicate with the electronic device 104 via the server 108. According to one embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to one embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to one embodiment, the auxiliary processor 123 (e.g., an ISP or a CP) may be implemented as a portion of another component (e.g., the camera module 180 or the communication module 190) that is functionally related to the auxiliary processor 123. According to one embodiment, the auxiliary processor 123 (e.g., an NPU) may include a hardware structure specified for artificial intelligence (AI) model processing. An AI model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to one embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to one embodiment, the display module 160 may include a touch sensor adapted to sense a touch, or a pressure sensor adapted to measure an intensity of a force incurred by the touch.

The audio module 170 may convert a sound into an electric signal or vice versa. According to one embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to one embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to one embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to one embodiment, the haptic module 179 may include, for example, a motor, a piezoelectric element, or an electric stimulator.

The camera module 180 may capture a still image and moving images. According to one embodiment, the camera module 180 may include one or more lenses, image sensors, ISPs, or flashes.

The power management module 188 may manage power supplied to the electronic device 101. According to one embodiment, the power management module 188 may be implemented as, for example, at least a part of a power management integrated circuit (PMIC).

The battery 189 may supply power to at least one component of the electronic device 101. According to one embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4^{th} generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a millimeter-wave (mmWave) band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199). According to one embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to one embodiment, the antenna module 197 may include an antenna including a radiating element including a conductive material or a conductive pattern formed in or on a substrate (e.g., a printed circuit board (PCB)). According to one embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one embodiment, another component (e.g., a radio frequency integrated circuit (RFIC)) other than the radiating element may be additionally formed as a part of the antenna module 197.

According to one embodiment, the antenna module 197 may form a mmWave antenna module. According to one embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one embodiment, all or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, e.g., distributed computing or mobile edge computing. In one embodiment, the external electronic device 104 may include an Internet-of-things (IoT) device. The server 108 may be an intelligent server using machine learning and/or a neural network. According to one embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various example embodiments of the disclosure and the terms used therein are not intended to limit the technological features set forth herein to particular embodiments and include various changes, equivalents, or replacements for a corresponding embodiment. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and may refer to components in other aspects (e.g., importance or order) is not limited. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various example embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

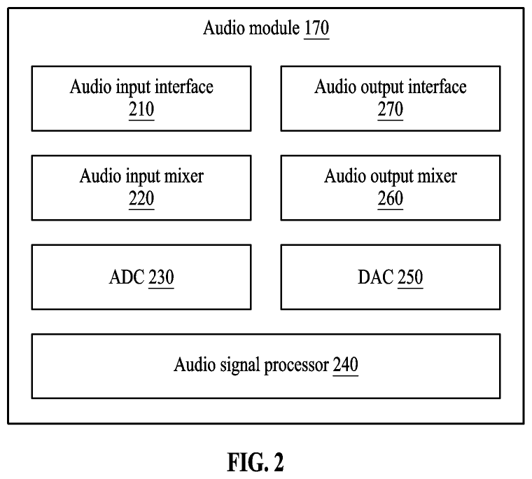

FIG. 2 is a block diagram of an audio module according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an example embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an example embodiment, additionally or alternatively, the audio input interface 210 may receive an audio signal from another component (e.g., the processor 120 or the memory 130 of FIG. 1) of the electronic device 101.

The audio input mixer 220 may synthesize a plurality of input audio signals into at least one audio signal. For example, according to an example embodiment, the audio input mixer 220 may synthesize a plurality of analog audio signals input via the audio input interface 210 into at least one analog audio signal.

The ADC 230 may convert an analog audio signal into a digital audio signal. For example, according to an example embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an example embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an example embodiment, one or more functions of the audio signal processor 240 may be implemented in the form of an equalizer.

The DAC 250 may convert a digital audio signal into an analog audio signal. For example, according to an example embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be output, into at least one audio signal. For example, according to an example embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an example embodiment, the sound output module 155 may include a plurality of speakers. In such a case, the audio output interface 270 may output audio signals having a plurality of different channels (e.g., stereo channels or 5.1 channels) via at least some of the plurality of speakers. According to an example embodiment, the audio output interface 270 may be connected with the external electronic device 102 (e.g., an external speaker or a headset) directly via the connecting terminal 178 or wirelessly via the wireless communication module 192 to output an audio signal.

According to an example embodiment, the audio module 170 may generate, without separately including the audio input mixer 220 or the audio output mixer 260, at least one digital audio signal by synthesizing a plurality of digital audio signals using at least one function of the audio signal processor 240.

According to an example embodiment, the audio module 170 may include an audio amplifier (not shown) (e.g., a speaker amplifying circuit) that is capable of amplifying an analog audio signal input via the audio input interface 210 or an audio signal that is to be output via the audio output interface 270. According to an example embodiment, the audio amplifier may be configured as a module separate from the audio module 170.

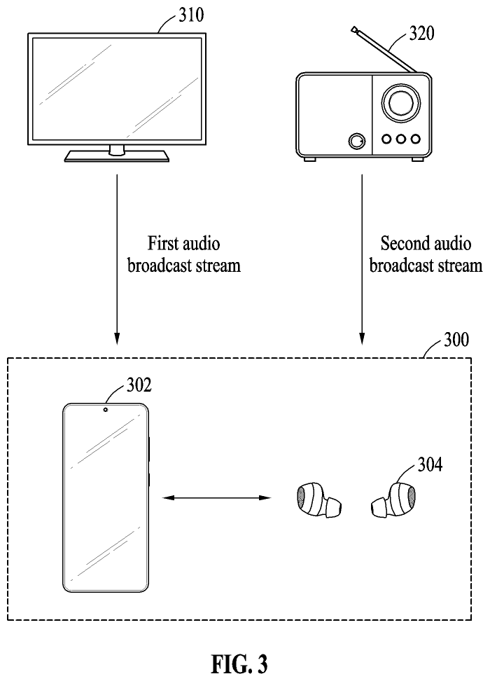

FIG. 3 is a diagram of an audio signal output system according to an embodiment of the disclosure.

Referring to FIG. 3, according to one embodiment, an audio signal output system 300 may include an electronic device 302 (e.g., the electronic device 101 of FIG. 1) and an audio output device 304 (e.g., the electronic device 102 or 104 of FIG. 1). For example, the audio output device 304 may be connected to the electronic device 302 through a wireless link and may exchange data with the electronic device 302 through the wireless link. For example, the wireless link may be Bluetooth, but is not limited thereto.

According to one embodiment, the audio output device 304 may provide a user with audio by outputting an audio signal received from the electronic device 302 through the wireless link. For example, the audio output device 304 may include a master device and a slave device worn on ears of the user, respectively.

According to one embodiment, to receive an audio signal from an audio source device to which Bluetooth legacy connection is applied, the electronic device 302 may detect the audio source device by scanning, pair with the detected audio source device, and may receive an audio signal in a paired state. For example, the received audio signal may be in the form of connected isochronous stream (CIS). According to the Bluetooth legacy connection, the electronic device may be required to be paired with an audio source device every time to receive an audio signal.

According to one embodiment, an audio source device 310 or 320 may broadcast an audio signal to the surroundings of the audio source device 310 or 320 in the form of broadcasting isochronous stream (BIS). For example, the electronic device 302 may detect information of the audio source devices 310 and 320 by scanning and may receive an audio signal by receiving BIS from the audio source device 310 or 320 based on the detected information. In other words, the electronic device 302 may receive an audio signal from the audio source device 310 or 320 without pairing with the audio source device 310 or 320. Since the audio source device 310 or 320 does not require pairing with the electronic device 302 to transmit an audio signal, the audio source device 310 or 320 may simultaneously broadcast an audio signal to a plurality of electronic devices.

According to one embodiment, when one or more audio source devices 310 and 320 are detected, the user of the electronic device 302 may select one from the audio source devices 310 and 320 to listen to audio. The electronic device 302 may generate a list of detected audio source lists for the user to select and may provide the list through a display (e.g., the display module 160 of FIG. 1) to the user. The user may select one from the audio source devices 310 and 320 through the list. The electronic device 302 may receive an audio signal by receiving BIS of the selected first audio source device 310 and may control the audio output device 304 to output the audio signal through the audio output device 304.

According to one embodiment, although it is described that the electronic device 302 receives the audio signal broadcasted by the audio source device 310 or 320, the audio output device 304 may also receive the audio signal broadcasted by the audio source device 310 or 320. That is, not only the electronic device 302 but also the audio output device 304 may support AoBLE.

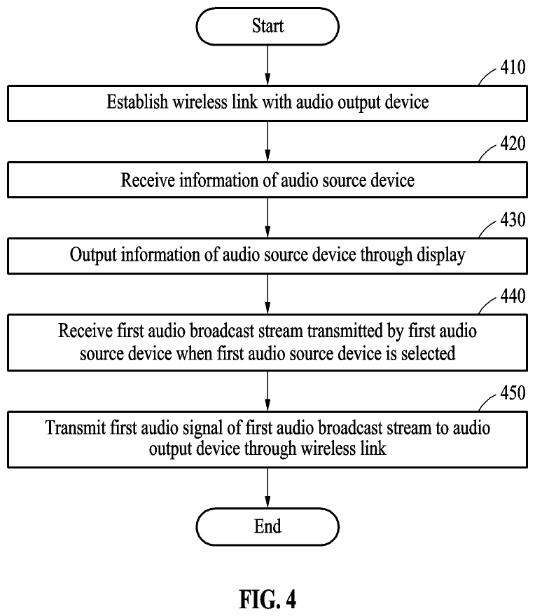

Hereinafter, a method of the audio source device 310 or 320 to output an audio signal through the audio signal output system 300 is described with reference to FIGS. 4 to 15.

FIG. 4 is a flowchart illustrating a method, performed by an electronic device, of outputting an audio signal according to an embodiment of the disclosure.

Operations 410 to 450 may be performed by an electronic device (e.g., the electronic device 101 of FIG. 1 or the electronic device 302 of FIG. 3). For example, the electronic device may include a processor (e.g., the processor 120 of FIG. 1), a communication module (e.g., the communication module 190 of FIG. 1), a memory (e.g., the memory 130 of FIG. 1), a display (e.g., the display module 160 of FIG. 1), and a sensor unit (e.g., the sensor module 176 of FIG. 1).

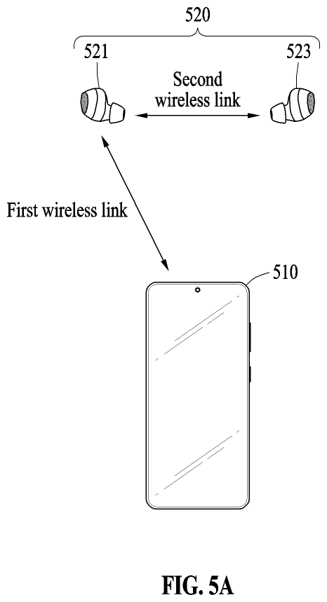

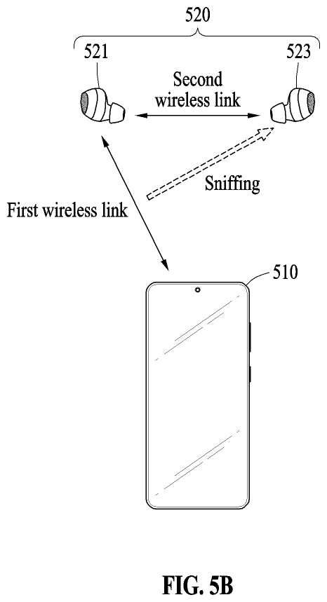

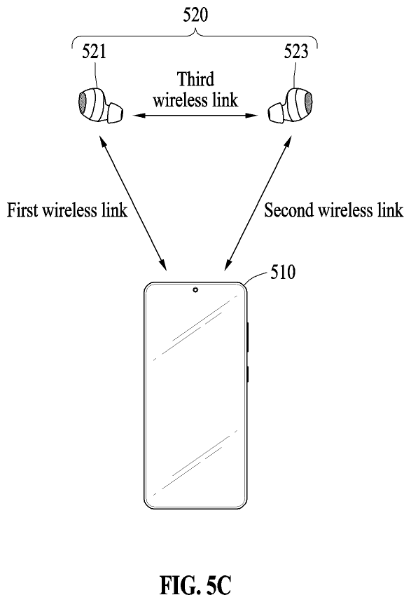

Referring to FIG. 4, in operation 410, the processor of the electronic device may establish a wireless link with an audio output device (e.g., the electronic device 102 or 104 of FIG. 1 or the audio output device 304 of FIG. 3) through the communication module. For example, the wireless link may be Bluetooth or Bluetooth low energy (BLE). A detailed description of the wireless link between the electronic device and the audio output device is provided below with reference to FIGS. 5A to 5C.

In operation 420, the processor may receive information of a first audio source device (e.g., the first audio source device 310 or the second audio source device 320 of FIG. 3) through the communication module. For example, the first audio source device may periodically broadcast information of the first audio source device and the electronic device may receive the broadcasted information of the first audio source device by scanning external data through the communication module. For example, the information of the audio source device may be periodic advertising broadcast (PADVB). For example, the information of the first audio source device may include at least one of identification information, account information, address information, clock information of the first audio of the first audio source device, information transmission power information on a first audio signal, and/or information of programs currently broadcast. The identification information may be information for distinguishing a type (e.g., a television, a personal computer, a laptop, a radio, a smartphone, or wireless earphones) of the audio source device. The account information may be information on an account used by an audio source. For example, the information on the audio signal may be information for receiving an Aux_Sync_IND packet and may include timing information and audio channel map information.

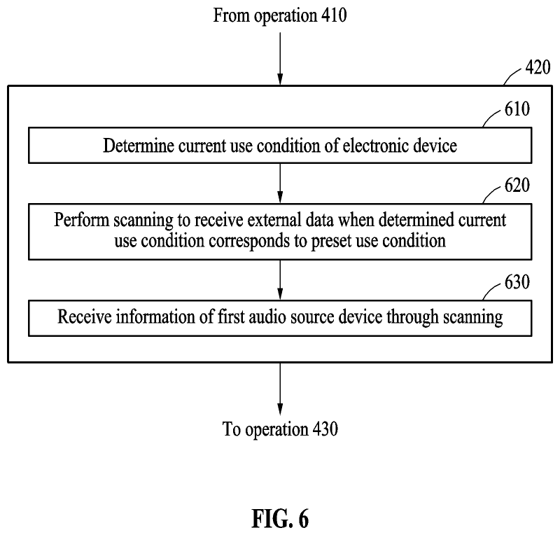

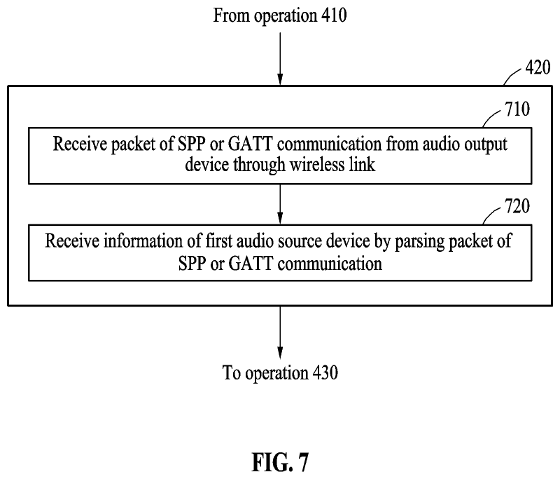

Hereinafter, a detailed description of a method of receiving information of the first audio source device is described with reference to FIGS. 6 and 7.

In operation 430, the processor may output the received information of the first audio source device through the display. For example, the processor may generate a list to include at least a portion of the information of the first audio source device and may output the generated list through the display.

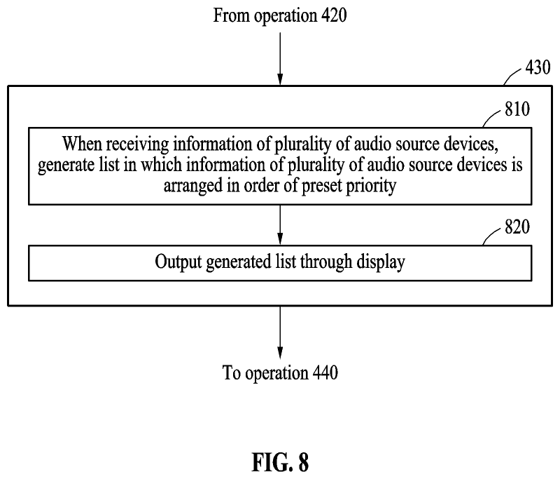

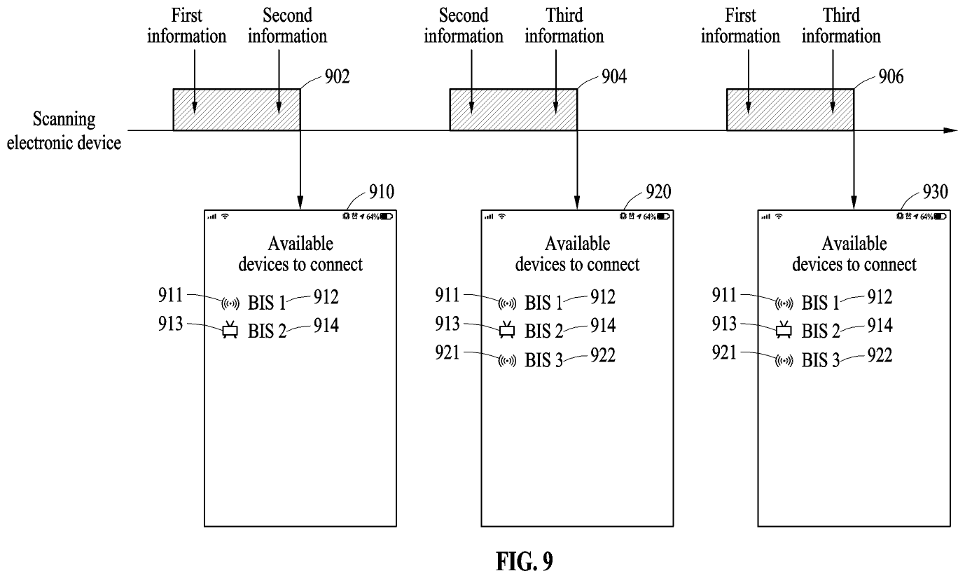

Hereinafter, a detailed description of a method of outputting information of the first audio source device is described with reference to FIGS. 8 and 9.

In operation 440, when the first audio source device is selected, the processor may receive a first audio broadcast stream transmitted by the first audio source device. For example, the user of the electronic device may select the first audio source device from one or more audio source devices output on the display through a user interface (UI) or user experience (UX). For example, when a plurality of audio source devices is detected, the plurality of audio source devices may be output on the display as a list and the user may select the first audio source device by selecting one from the list.

According to one embodiment, the processor may identify the first audio broadcast stream transmitted by the first audio source device based on at least one of the address information and the clock information included in the information of the first audio source device and may receive the identified first audio broadcast stream. For example, the received first audio broadcast stream may be BIS.

In operation 450, the processor may transmit a first audio signal of the first audio broadcast stream to the audio output device through the wireless link established with the audio output device. The audio output device that received the first audio signal from the electronic device may provide audio to the user by outputting the first audio signal.

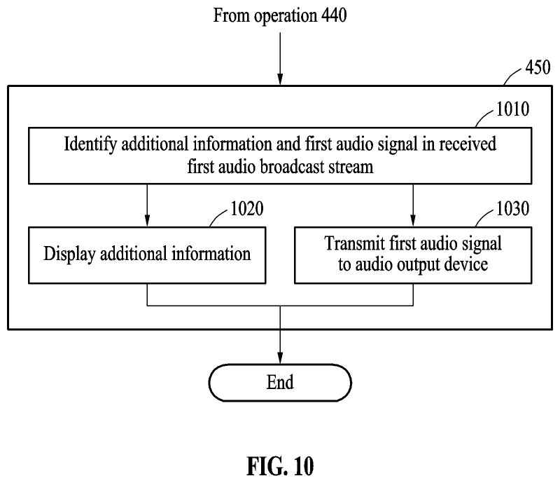

Hereinafter, a detailed description of a method of transmitting the first audio signal to the audio output device is described with reference to FIG. 10.

According to one embodiment, the electronic device 101 may include the display module 160, the communication module 190 for exchanging data with an external device, and at least one processor 120 connected to the display module 160 and the communication module 190. The processor 120 may receive information of the first audio source device through the communication module 190, may output the received information of the first audio source device through a display of the display module 160, may receive the first audio broadcast stream transmitted by the first audio source device when the first audio source device is selected by the user, may transmit the first audio signal of the first audio broadcast stream to the audio output device through the wireless link established with the audio output device through the communication module 190, and may allow the first audio signal to be output through the audio output device.

According to one embodiment, the processor 120 may establish a wireless link with the audio output device through the communication module 190 and the wireless link may be Bluetooth or BLE.

According to one embodiment, the method of outputting an audio signal performed by the electronic device 101 may include operation 420 of receiving information of the first audio source device through the communication module 190, operation 430 of outputting the received information of the first audio source device through the display, operation 440 of receiving the first audio broadcast stream transmitted by the first audio source device when the user selects the first audio source device, and operation 450 of transmitting the first audio signal of the first audio broadcast stream to the audio output device through a wireless link established with the audio output device through the communication module. The first audio signal may be output through the audio output device.

FIGS. 5A, 5B, and 5C are diagrams illustrating a wireless link established between an electronic device and an audio output device according to various embodiments of the disclosure.

According to one embodiment, an audio output device 520 (e.g., the electronic device 102 or 104 of FIG. 1, or the audio output device 304 of FIG. 3) may include a master device 521 and a slave device 523. For example, the master device 521 may be a device worn on a left ear (or a right ear) of a user, and the slave device 523 may be a device worn on a right ear (or the left ear) of the user. For example, an additional wireless link may be established between the master device 521 and the slave device 523 for exchanging data between the devices 521 and 523.

Referring to FIG. 5A, a first wireless link may be established between an electronic device 510 (e.g., the electronic device 101 of FIG. 1 or the electronic device 302 of FIG. 3) and the master device 521, and a first audio signal may be transmitted by the electronic device 510 to the master device 521 through the first wireless link. In addition, the master device 521 may transmit the first audio signal received from the electronic device 510 through a second wireless link that is an additional wireless link established between the master device 521 and the slave device 523. Data for synchronizing the time of output audio between the master device 521 and the slave device 523 may be exchanged through the second wireless link.

Referring to FIG. 5B, the first wireless link may be established between the electronic device 510 and the master device 521 and the first audio signal may be transmitted to the master device 521 from the electronic device 510 through the first wireless link. The master device 521 may transmit information on the first wireless link to the slave device 523 through a second wireless link that is an additional wireless link established between the master device 521 and the slave device 523. For example, the information on the first wireless link may include address information (e.g., a Bluetooth address of a master device of a first link, a Bluetooth address of the electronic device 510, and/or a Bluetooth address of the master device 521), piconet clock information (e.g., clock native (CLKN) of a master device of a first link), logical transport (LT) address information (e.g., information allocated by a master device of a first link), used channel map information, link key information, information on a service and/or profile related to service discovery protocol (SDP) information (e.g., a first link), and/or supported feature information. The slave device 523 may receive the first audio signal by sniffing information transmitted through the first wireless link based on the received information on the first wireless link. Data for synchronizing the time of output audio between the master device 521 and the slave device 523 may be exchanged through the second wireless link.

Referring to FIG. 5C, the first wireless link may be established between the electronic device 510 and the master device 521 and the second wireless link may be established between the electronic device 510 and the slave device 523. The master device 521 and the slave device 523 may receive the first audio signal from the electronic device 510 through wireless links, respectively. In addition, data for synchronizing the time of audio may be exchanged through a third wireless link that is an additional wireless link established between the master device 521 and the slave device 523. For example, the third wireless link may be proactively established before the first wireless link and/or the second wireless link is established.

According to one embodiment, the audio output device 520 may include the master device 521 and the slave device 523 and a wireless link may be established between the electronic device 510 and the master device 521.

According to one embodiment, an output of the first audio signal may be synchronized between the master device 521 and the slave device 523 through an additional wireless link between the master device 521 and the slave device 523.

FIG. 6 is a flowchart illustrating a method of receiving information of an audio source device according to an embodiment of the disclosure.

According to one embodiment, operation 420 described above with reference to FIG. 4 may include the following operations 610 to 630. Operations 610 to 630 may be performed by an electronic device (e.g., the electronic device 101 of FIG. 1, the electronic device 302 of FIG. 3, or the electronic device 510 of FIGS. 5A to 5C).

Referring to FIG. 6, in operation 610, a processor (e.g., the processor 120 of FIG. 1) of the electronic device may determine a current use condition of the electronic device.

For example, whether a cycle set for scanning has arrived may be determined to be the current use condition.

For example, whether a scan request of a user of the electronic device is received may be determined to be the current use condition. According to one embodiment, the scan request of the user may be received through a UI or UX of the electronic device. According to one embodiment, the user may input the scan request through a physical button or a soft button of an audio output device (e.g., the electronic device 102 or 104 of FIG. 1, the audio output device 304 of FIG. 3, or the audio output device 520 of FIGS. 5A to 5C) and when the scan request is input, the audio output device may transmit the scan request of the user through a wireless link (e.g., the first wireless link) established with the electronic device. For example, the user may input the scan request by a long press on a physical button of the audio output device.

For example, a current position of the electronic device may be determined to be the current use condition. The current position may be determined through a global navigation satellite system (GNSS) communication module of the electronic device.

For example, context information in which the user uses the electronic device may be determined to be the current use condition. For example, an operation of the user to execute a predetermined application or a near field communication (NFC) tag operation may be the context information.

In operation 620, the processor may perform scanning to receive external data when the determined current use condition corresponds to a preset use condition.

For example, when the cycle set for scanning has arrived, scanning may be performed.

For example, when the scan request is received from the user, scanning may be performed.

For example, when the determined current position of the electronic device corresponds to a preset position, such as a train, subway, or a bus stop, scanning may be performed to receive an audio signal propagated for the public purpose.

For example, when the user performs an NFC tag operation to use a transportation card, scanning may be performed to receive an audio signal related to corresponding transportation.

In operation 630, the processor may receive information of the first audio source device through scanning. For example, the processor may receive information of one or more audio source devices while scanning.

According to one embodiment, the processor of the electronic device may determine the current use condition of the electronic device, may perform scanning for receiving external data through the communication module when the determined current use condition corresponds to a preset use condition, and information of the first audio source device may be received through the scan.

FIG. 7 is a flowchart illustrating a method of receiving information of an audio source device from an audio output device according to an embodiment of the disclosure.

According to one embodiment, operation 420 described above with reference to FIG. 4 may include the following operations 710 and 720. Operations 710 and 720 may be performed by an electronic device (e.g., the electronic device 101 of FIG. 1, the electronic device 302 of FIG. 3, or the electronic device 510 of FIGS. 5A to 5C).

Operation 420 described with reference to FIG. 6 may include operations 610 to 630 for an electronic device to perform scanning, however, operation 420 described with reference to FIG. 7 may include operations 710 and 720 when scanning is performed by an audio output device (e.g., the electronic device 102 or 104 of FIG. 1, or the audio output device 304 of FIG. 3).

According to one embodiment, when an audio output device performs scanning, operation 710 may be performed. For example, a user may instruct the audio output device to scan based on a soft button or a physical button formed at least a portion of the audio output device. When scanning is performed, the audio output device may perform serial port profile (SPP) or generic attribute profile (GATT) communication through a wireless link (e.g., the first wireless link) established with the electronic device. Information of the first audio source device may be transmitted to the electronic device as a result of scanning through SPP or GATT communication. For example, SPP or GATT communication may be performed when a button input of the user is performed on the audio output device or at a preset cycle.

Referring to FIG. 7, in operation 710, a processor (e.g., the processor 120 of FIG. 1) of the electronic device may receive a packet of SPP or GATT communication from the audio output device through a wireless link (e.g., the first wireless link) established with the audio output device. The information of the first audio source device received through scanning by the audio output device may be included in the packet of SPP or GATT communication. For example, the information of the first audio source device may be generated in the form of a packet of SPP or GATT communication. For example, the audio output device may generate a packet of SPP or GATT communication by adding information of the first audio source device to information included in the existing packet of SPP or GATT communication.

In operation 720, the processor may receive the information of the first audio source device by parsing the received packet of SPP or GATT communication.

According to one embodiment, the electronic device may receive the information of the first audio source device received by the audio output device through a wireless link established with the audio output device.

FIG. 8 is a flowchart illustrating a method of outputting information of an audio source device according to an embodiment of the disclosure.

According to one embodiment, operation 430 described above with reference to FIG. 4 may include the following operations 810 and 820. Operations 810 and 820 may be performed by an electronic device (e.g., the electronic device 101 of FIG. 1, the electronic device 302 of FIG. 3, or the electronic device 510 of FIGS. 5A to 5C).

Referring to FIG. 8, in operation 810, when a processor (e.g., the processor 120 of FIG. 1) of the electronic device receives information of a plurality of audio source devices by scanning, the processor may generate a list in which pieces of information of the plurality of audio source devices arranged in order of preset priority.

For example, the preset priority may be a bit rate of audio broadcast stream, address information, a distance calculated based on a signal intensity, a name of an audio source device, a reception order of the information of the audio source device, or priority set by a user.

According to one embodiment, when the processor receives the information of the audio source device, the processor may request the audio source device for detailed information based on the received information. The audio source device may transmit the detailed information to the electronic device. For example, the detailed information may be information that is not included in the information of the audio source device. Based on the received detailed information, the processor may arrange the plurality of audio source devices in the order of preset priority.

In operation 820, the processor may output the generated list on a display (e.g., the display module 160 of FIG. 1).

According to one embodiment, when the processor of the electronic device receives information of the plurality of audio source devices, the processor of the electronic device may generate a list in which the information of the plurality of audio source devices is arranged in order of preset priority and may output the generated list on the display.

FIG. 9 illustrates a list generated to show, through user experience (UX) of an electronic device, a plurality of audio source devices detected by scanning according to an embodiment of the disclosure.

Referring to FIG. 9, according to one embodiment, an electronic device (e.g., the electronic device 101 of FIG. 1, the electronic device 302 of FIG. 3, or the electronic device 510 of FIGS. 5A to 5C) may perform multiple scans 902, 904, and 906 having intervals therebetween. For example, the time when the scans 902, 904, and 906 are performed may correspond to some of the channels or time slots of wireless communication used by the electronic device.

Through the scan 902, first information of the first audio source device and second information of the second audio source device may be received. The electronic device may generate and output a first list 910 to show the first information and the second information.

The first information shown in the first list 910 may include a first icon 911 and a first identifier 912 and the second information may include a second icon 913 and a second identifier 914. The first icon 911 may graphically show the shape of the first audio source device. The first identifier 912 may be an identifier to identify the first audio source device or the first audio signal.

Through the scan 904, the second information of the second audio source device and third information of a third audio source device may be received. A second list 920 may be generated by updating the first list 910 to show the new third information and the second list 920 may be output. The third information may include a third icon 921 and a third identifier 922. Even when the first information of the first audio source device is not received through the scan 904, the first information may be included in the second list 920 based on a preset list generation condition. For example, when the preset list generation condition is set that a list only includes information of an audio source device received through the current scan, the second list 920 may not include the first information.

Through the scan 906, the first information of the first audio source device and the third information of the third audio source device may be received. Because new information is not received compared to the previous case, a third list 930 generated by the scan 906 may be the same as the second list 920. For example, when the preset list generation condition is set that a list only includes an audio source device received through the current scan, the third list 930 may only include the first information and the third information. For example, the preset list generation condition may be that a list includes information of an audio source device received during a preset number of times of scans.

The user may select one from the first information, the second information, and the third information shown in the third list 930. For example, the user may select the first information by touching an area of a display corresponding to the first information (e.g., the first icon 911 and the first identifier 912). The electronic device may receive a first audio broadcast stream propagated by the first audio source device based on the first information.

According to one embodiment, the electronic device may perform a plurality times of scans 902, 904, and 906 and may generate and/or display a list based on scan results.

According to one embodiment, the method of generating a list described with reference to FIG. 9 is described based on a case in which a scan is performed by the electronic device. However, the method may be similarly applicable to a case in which a scan is performed by an audio output device (e.g., the electronic device 102 or 104 of FIG. 1, the audio output device 304 of FIG. 3, or the audio output device 520 of FIGS. 5A to 5C) or a case in which the electronic device receives a scan result from the audio output device. For example, after operation 720 described above with reference to FIG. 7, the electronic device may generate a list based on information of the first audio source device received by parsing a packet of SPP or GATT communication.

FIG. 10 is a flowchart illustrating a method of outputting additional information based on audio broadcast stream according to an embodiment of the disclosure.

According to one embodiment, operation 450 described above with reference to FIG. 4 may include the following operations 1010 to 1030. Operations 1010 to 1030 may be performed by an electronic device (e.g., the electronic device 101 of FIG. 1, the electronic device 302 of FIG. 3, or the electronic device 510 of FIGS. 5A to 5C).

Referring to FIG. 10, in operation 1010, a processor (e.g., the processor 120 of FIG. 1) of the electronic device may identify additional information and a first audio signal in a first audio broadcast stream that is received. For example, the additional information may be information (e.g., video information or a uniform resource locator (URL)) that is not an audio signal.

In operation 1020, the processor may display the additional information.

In operation 1030, the processor may transmit the first audio signal to an audio output device (e.g., the electronic device 102 or 104 of FIG. 1, the audio output device 304 of FIG. 3, or the audio output device 520 of FIGS. 5A to 5C) through a wireless link.

According to one embodiment, operations 1020 and 1030 may be performed in parallel or substantially simultaneously.

According to one embodiment, when the additional information is video information, the electronic device and the audio output device may be controlled to temporally synchronize a video on the video information with audio on the audio signal and output the video and the audio to the user.

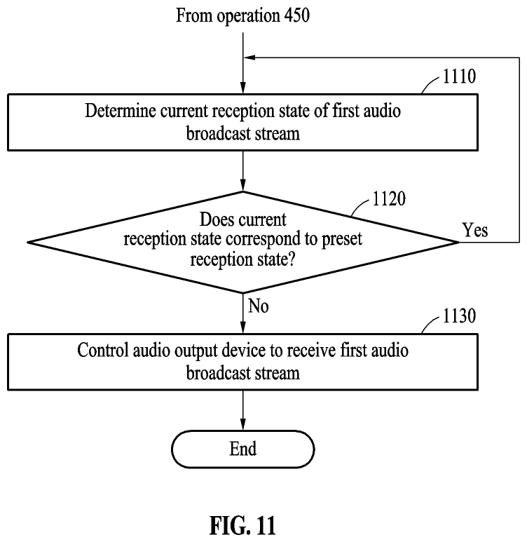

FIG. 11 is a flowchart illustrating a method of an electronic device to control an audio output device to receive audio broadcast stream according to an embodiment of the disclosure.

According to one embodiment, after operation 450 described above with reference to FIG. 4, the following operations 1110 to 1130 may be performed. Operations 1110 to 1130 may be performed by an electronic device (e.g., the electronic device 101 of FIG. 1, the electronic device 302 of FIG. 3, or the electronic device 510 of FIGS. 5A to 5C).

Referring to FIG. 11, in operation 1110, a processor (e.g., the processor 120 of FIG. 1) of the electronic device may determine a current reception state of a first audio broadcast stream. For example, the reception state may be determined based on at least one of reception sensitivity of the received first audio broadcast stream, an acknowledged (ACK) ratio, and a retransmission ratio. For example, the determined current reception state may be one of a plurality of preset levels.

According to one embodiment, when an obstacle exists in a path through which the first audio broadcast stream is received, the reception state of the first audio broadcast stream may be degraded. For example, when a user puts an electronic device in their pocket, the reception state of the first audio broadcast stream may be relatively poor compared to when the user does not put the electronic device in their pocket.

In operation 1120, the processor may determine whether the current reception state corresponds to the preset reception state. For example, the preset reception state may be a threshold level corresponding to a state in which audio is appropriately provided to the user. The threshold level may vary depending on settings of the user.

According to one embodiment, the processor of the electronic device may determine the current reception state of the first audio broadcast stream and when the current reception state corresponds to the preset reception state, the electronic device may receive the first audio broadcast stream.

According to one embodiment, the processor of the electronic device may determine the current reception state of the first audio broadcast stream and when the current reception state does not correspond to the preset reception state, in operation 1130, the processor may control an audio output device (e.g., the electronic device 102 or 104 of FIG. 1, the audio output device 304 of FIG. 3, or the audio output device 520 of FIGS. 5A to 5C) to receive the first audio broadcast stream.

According to one embodiment, the processor may transmit information required to receive the first audio broadcast stream to the audio output device through a wireless link. For example, at least one of address information and clock information included in the information of the first audio source device may be transmitted to the audio output device. The audio output device may identify the first audio broadcast stream based on the information received from the electronic device and may receive the identified first audio broadcast stream.

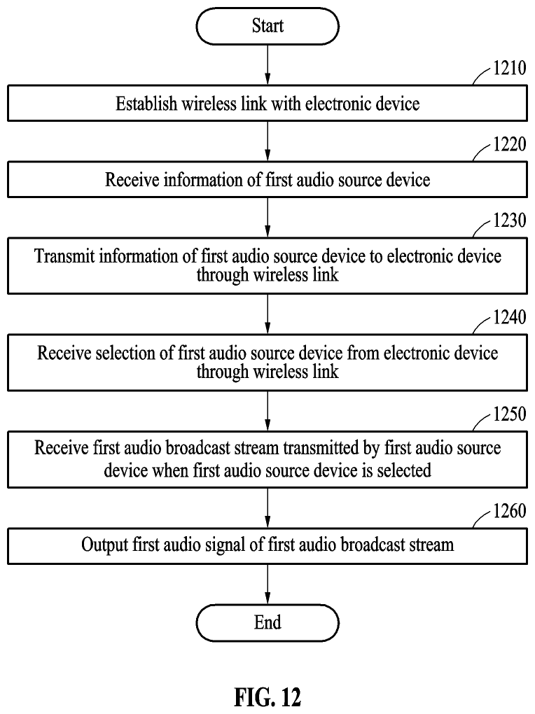

FIG. 12 is a flowchart illustrating a method, performed by an audio output device, of outputting an audio signal according to an embodiment of the disclosure.

Operations 1210 to 1260 may be performed by an audio output device (e.g., the electronic device 102 or 104 of FIG. 1, the audio output device 304 of FIG. 3, or the audio output device 520 of FIGS. 5A to 5C). For example, the audio output device may include a processor, a communication module, a memory, a sensor unit, and a battery. The descriptions of the processor, the communication module, the memory, the sound output module, the sensor unit, and the battery of the audio output device may be replaced with the descriptions of the processor 120, the communication module 190, the memory 130, the sound output module 155, the sensor module 176, and the battery 189 provided with reference to FIG. 1.

Referring to FIG. 12, in operation 1210, the processor of the audio output device may establish a wireless link with an electronic device (e.g., the electronic device 101 of FIG. 1, the electronic device 302 of FIG. 3, or the electronic device 510 of FIGS. 5A to 5C) through the communication module. For example, the wireless link may be Bluetooth or BLE.

In operation 1220, the processor may receive information of a first audio source device (e.g., the first audio source device 310 or the second audio source device 320 of FIG. 3) through the communication module. For example, the first audio source device may periodically broadcast information of the first audio source device and the audio output device may receive the broadcasted information of the first audio source device by scanning external data through the communication module. For example, information of the audio source device may be PADVB. For example, the information of the first audio source device may include at least one of identification information, account information, address information, clock information of the first audio source device, information on the first audio signal, timing information, transmission power information, and audio channel map information. According to one embodiment, when the processor scans external data through the communication module, the processor may receive information of a plurality of audio source devices including the first audio source device.

In operation 1230, the processor may transmit the information of the first audio source device to the electronic device through a wireless link established with the electronic device. According to one embodiment, the processor may transmit the information of the plurality of audio source devices to the electronic device.

According to one embodiment, the electronic device that receives the information of the first audio source device from the audio output device may output the information of the first audio source device through a display (e.g., operation 430 of FIG. 4), may receive a selection of the user of the first audio source device, and may transmit the selection of the first audio source device to the audio output device.

According to one embodiment, the electronic device that receives the information of the first audio source device from the audio output device may output, through the display, the information of the first audio source device together with information of a second audio source device received by scanning of the electronic device. The user may select one of the information of the first audio source device and the information of the second audio source device. For example, when the user selects the information of the first audio source device, operation 1240 below may be performed. For example, when the user selects the information of the second audio source device, operations 440 and 450 described above with reference to FIG. 4 may be performed and in operation 450, the audio signal output device may be controlled by the electronic device to output the second audio signal of the second audio broadcast stream transmitted by the second audio source device.

In operation 1240, the processor may receive a selection of the first audio source device from the electronic device through a wireless link.

In operation 1250, when the first audio source device is selected, the processor may receive a first audio broadcast stream transmitted by the first audio source device.

According to one embodiment, the processor may identify the first audio broadcast stream based on at least one of the address information and the clock information included in the information of the first audio source device and may receive the identified first audio broadcast stream. For example, the received first audio broadcast stream may be BIS.

In operation 1260, the processor may output the first audio signal of the first audio broadcast stream. For example, the processor may provide audio to the user by outputting the first audio signal through the sound output module.

According to one embodiment, the audio output device may include the communication module configured to exchange data with an external device and at least one processor configured to control the audio output device. The processor may receive the information of the first audio source device through the communication module, may transmit the information of the first audio source device to the electronic device through a wireless link established with the electronic device through the communication module, when the first audio source device is selected by the user, may receive the first audio broadcast stream transmitted by the first audio source device, and may output the first audio signal of the first audio broadcast stream.

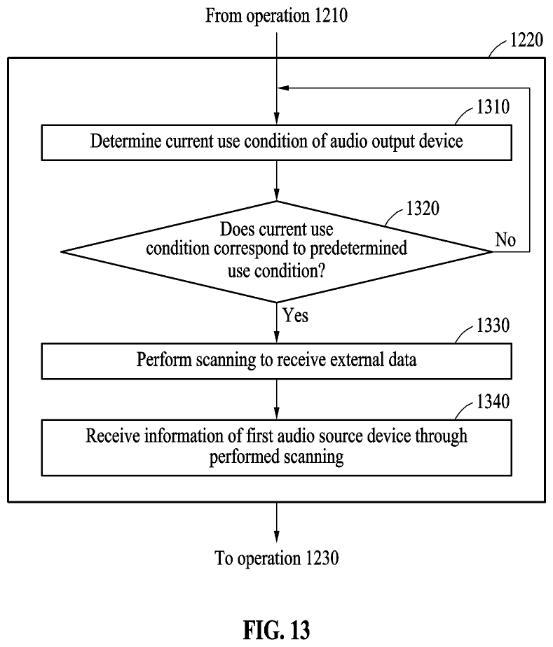

FIG. 13 is a flowchart illustrating a method of receiving information of an audio source device according to an embodiment of the disclosure.

According to one embodiment, operation 1220 described above with reference to FIG. 12 may include the following operations 1310 to 1340. Operations 1310 to 1340 may be performed by an audio output device (e.g., the electronic device 102 or 104 of FIG. 1, the audio output device 304 of FIG. 3, or the audio output device 520 of FIGS. 5A to 5C).

Referring to FIG. 13, in operation 1310, a processor of the audio output device may determine a current use condition of the audio output device.

For example, whether a cycle set for scanning has arrived may be determined to be the current use condition.

For example, whether a scan request of a user of the audio output device is received may be determined to be the current use condition. The user may input the scan request to the audio output device through a UI (e.g., a touch sensor or a physical button) of the audio output device.

According to one embodiment, the processor of the audio output device may determine the current use condition based on an event of a touch input or an event of a button input to the audio output device. For example, the processor may determine the current use condition based on a remaining capacity of a battery of the audio output device. In operation 1320, the processor may determine whether the current use condition corresponds to a predetermined use condition.

In operation 1330, the processor may perform scanning to receive external data when the determined current use condition corresponds to a preset use condition.

For example, when the cycle set for scanning has arrived, scanning may be performed.

For example, when the scan request is received from the user, scanning may be performed.

For example, when data obtained by the sensor module 176 is predetermined data (e.g., a gesture or motion), the processor may perform scanning.

In operation 1340, the processor may receive information of the first audio source device through scanning. For example, the processor may receive information of one or more audio source devices while scanning.

According to one embodiment, the processor of the audio output device may determine the current use condition of the audio output device, may perform scanning for receiving external data through the communication module when the determined current use condition corresponds to a preset use condition, and information of the first audio source device may be received through the scan.

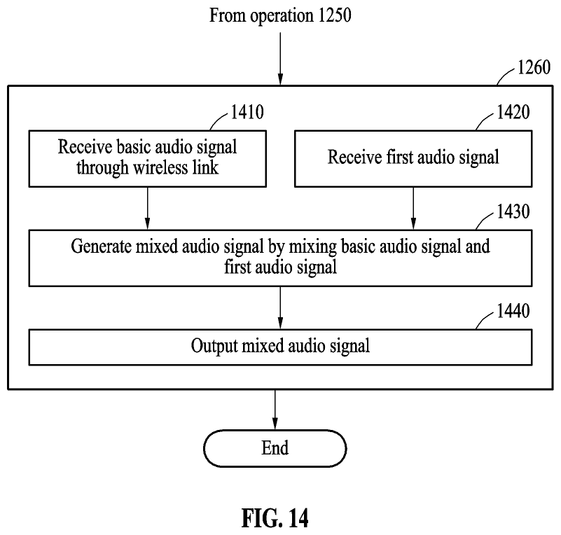

FIG. 14 is a flowchart illustrating a method of outputting a mixed audio signal according to an embodiment of the disclosure.

According to one embodiment, operation 1260 described above with reference to FIG. 12 may include the following operations 1410 to 1440. Operations 1410 to 1440 may be performed by an audio output device (e.g., the electronic device 102 or 104 of FIG. 1, the audio output device 304 of FIG. 3, or the audio output device 520 of FIGS. 5A to 5C).

Referring to FIG. 14, in operation 1410, a processor of the audio output device may receive a basic audio signal through a wireless link. The basic audio signal may be a signal transmitted by an electronic device (e.g., the electronic device 101 of FIG. 1, the electronic device 302 of FIG. 3, or the electronic device 510 of FIGS. 5A to 5C) to the audio output device. For example, the electronic device may play a sound source through an application and may transmit an audio signal of the sound source as a basic audio signal to the audio output device. The basic audio signal may be a media packet.

In operation 1420, the processor may receive the first audio signal from the first audio broadcast stream. For example, the basic audio signal and the first audio signal may be received by different time slots by scheduling. The first audio broadcast stream for the first audio signal may be irregularly received in a time slot remaining after receiving the basic audio signal. For example, the irregular first audio broadcast stream may be a broadcast (e.g., a subway broadcast) propagated for the public purpose.

According to one embodiment, operations 1410 and 1420 may be performed in parallel or substantially simultaneously.

According to one embodiment, when the basic audio signal is a signal that corresponds to an important event, such as a phone call, a time slot for receiving the first audio broadcast stream for the first audio signal may not be allocated.

In operation 1430, the processor may generate a mixed audio signal by mixing the basic audio signal and the first audio signal.

According to one embodiment, when the audio output device and the electronic device establish a wireless link described with reference to FIG. 5A, a master device (e.g., the master device 521) of the audio output device may receive the basic audio signal and the first audio signal and may generate a mixed audio signal by mixing the basic audio signal and the first audio signal. The master device may transmit the generated mixed audio signal to the slave device (e.g., the slave device 523).

According to one embodiment, when the audio output device and the electronic device establish a wireless link described with reference to FIG. 5B, the master device and the slave device of the audio output device may receive the first audio signal and the master device may further receive the basic audio signal from the electronic device. The master device may transmit the received basic audio signal to the slave device and the master device and the slave device each may generate a mixed audio signal by mixing the basic audio signal and the first audio signal.

According to one embodiment, when the audio output device and the electronic device establish a wireless link described with reference to FIG. 5C, the master device and the slave device of the audio output device may receive the first audio signal from the first audio broadcast stream and may also receive the basic audio signal from the electronic device. The master device and the slave device each may generate a mixed audio signal by mixing the basic audio signal and the first audio signal and may synchronize an output of the mixed audio signal through a wireless link (e.g., the third wireless link) between the master device and the slave device.

In operation 1440, the processor may output the mixed audio signal. The user may simultaneously listen to the basic audio and the first audio as the mixed audio signal is output.

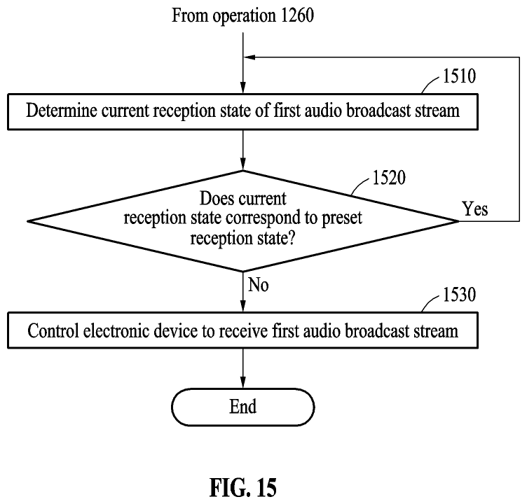

FIG. 15 is a flowchart illustrating a method of an audio output device to control an electronic device to receive audio broadcast stream according to an embodiment of the disclosure.

According to one embodiment, after operation 1260 described above with reference to FIG. 12, the following operations 1510 to 1530 may be performed. Operations 1510 to 1530 may be performed by an audio output device (e.g., the electronic device 102 or 104 of FIG. 1, the audio output device 304 of FIG. 3, or the audio output device 520 of FIGS. 5A to 5C).

Referring to FIG. 15, in operation 1510, a processor of the audio output device may determine a current reception state of a first audio broadcast stream. For example, the reception state may be determined based on at least one of reception sensitivity of the received first audio broadcast stream, an acknowledged (ACK) ratio, and a retransmission ratio. For example, the determined current reception state may be one of a plurality of preset levels.

According to one embodiment, when an obstacle exists in a path through which the first audio broadcast stream is received, the reception state of the first audio broadcast stream may be degraded.

According to one embodiment, a remaining capacity of a battery of the audio output device may be determined to be the current reception state.

In operation 1520, the processor may determine whether the current reception state corresponds to a preset reception state. For example, the preset reception state may be a threshold level corresponding to a state in which audio is appropriately provided to the user. The threshold level may vary depending on the settings of the user. For example, the preset reception state may be a threshold battery remaining capacity.

According to one embodiment, when the current reception state corresponds to the preset reception state, the audio output device may receive the first audio broadcast stream and may continuously perform an output operation. For example, when the preset reception state is greater than or equal to a threshold level and/or the remaining capacity of the battery is greater than or equal to the threshold level, the audio output device may receive the first audio broadcast stream and may continuously perform an output operation.

According to one embodiment, when the current reception state does not correspond to the preset reception state, in operation 1530, the processor may control an electronic device (e.g., the electronic device 101 of FIG. 1, the electronic device 302 of FIG. 3, or the electronic device 510 of FIGS. 5A to 5C) to receive the first audio broadcast stream.

According to one embodiment, the audio output device may transmit information required to receive the first audio broadcast stream to the electronic device through a wireless link. For example, at least one of address information and clock information included in the information of the first audio source device may be transmitted to the electronic device. The electronic device may identify the first audio broadcast stream based on the information received from the audio output device and may receive the identified first audio broadcast stream.

According to one embodiment, when the current reception state of the first audio broadcast stream does not correspond to the preset reception state, the audio output device may perform operation 1330 of scanning to receive external data and may transmit a result of performing to the electronic device.

According to one embodiment, operations 1510 and 1520 may be performed by a first device (e.g., the master device 521) of the audio output device and when it is determined that the current reception state does not correspond to the preset reception state through the first device in operation 1520, the first device may control a second device (e.g., the slave device 523) of the audio output device to receive the first audio broadcast stream. For example, the audio output device may receive the first audio broadcast stream transmitted by the first audio source device through the second device (operation 1250) and may output the first audio signal of the first audio broadcast stream (operation 1260). Operations 1510 and 1520 may be performed on the second device and when it is determined that the current reception state does not correspond to the preset reception state through the second device in operation 1520, the audio output device may control another device (e.g., the first device or the electronic device) to receive the first audio broadcast stream.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processing (DSP), a microcomputer, a field-programmable gate array (FPGA), a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display module;
a communication module configured to exchange data with an external device; and
at least one processor connected to the display module and the communication module,
wherein the processor is configured to:
receive information of a first audio source device through the communication module,
output the received information of the first audio source device through a display of the display module,
when a user selects the first audio source device, receive first audio broadcast stream transmitted by the first audio source device,
transmit a first audio signal of the first audio broadcast stream to an audio output device through wireless link established with the audio output device through the communication module, and
cause the first audio signal to be output through the audio output device.

2. The electronic device of claim 1, wherein the at least one processor is further configured to establish the wireless link with the audio output device through the communication module.

3. The electronic device of claim 1, wherein the wireless link is Bluetooth or Bluetooth low energy (BLE).

4. The electronic device of claim 1,
wherein the audio output device comprises a master device and a slave device, and
wherein the wireless link is established between the electronic device and the master device.

5. The electronic device of claim 1, wherein the information of the first audio source device comprises at least one of identification information of the first audio source device, account information, address information, clock information, information on the first audio signal, timing information, transmission power information, or audio channel map information.

6. The electronic device of claim 1, wherein the at least one processor is further configured to:
determine a current use condition of the electronic device,
when the determined current use condition corresponds to a preset use condition, perform scanning to receive external data through the communication module, and
receive the information of the first audio source device through the performed scanning.

7. The electronic device of claim 1, wherein the at least one processor is further configured to receive the information of the first audio source device received by the audio output device through the wireless link established with the audio output device.

8. The electronic device of claim 1, wherein the at least one processor is further configured to:
when receiving information of a plurality of audio source devices, generate a list in which the information of the plurality of audio source devices is arranged in order of a preset priority, and
output the generated list through the display.

9. The electronic device of claim 1, wherein the at least one processor is further configured to, when the first audio source device is selected, receive the first audio broadcast stream based on at least one of address information and clock information included in the information of the first audio source device.

10. The electronic device of claim 1, wherein the at least one processor is further configured to:
determine a current reception state of the first audio broadcast stream, and
when the current reception state does not correspond to a preset reception state, control the audio output device to receive the first audio broadcast stream.

11. The electronic device of claim 1, wherein the electronic device is a mobile communication terminal.

12. A method of outputting an audio signal, performed by an electronic device, the method comprising:
receiving information of a first audio source device through a communication module;
outputting the received information of the first audio source device through a display of a display module;
when a user selects the first audio source device, receiving first audio broadcast stream transmitted by the first audio source device; and
causing a first audio signal to be output by an audio output device by transmitting the first audio signal of the first audio broadcast stream to the audio output device through wireless link established with the audio output device through the communication module.

13. An audio output device comprising:
a communication module configured to exchange data with an external device; and
at least one processor connected to the communication module,
wherein the at least one processor is configured to:
receive information of a first audio source device through the communication module,
transmit information of the first audio source device to an electronic device through wireless link established with the electronic device through the communication module,
when the first audio source device is selected by the electronic device, receive first audio broadcast stream transmitted by the first audio source device, and
output a first audio signal of the first audio broadcast stream.

14. The audio output device of claim 13, wherein the at least one processor is further configured to receive selection of the first audio source device by the electronic device through the wireless link.

15. The audio output device of claim 13, wherein the at least one processor is further configured to:
determine a current use condition of the audio output device,
when the determined current use condition corresponds to a preset use condition, perform scanning to receive external data through the communication module, and
receive the information of the first audio source device through the performed scanning.

16. The audio output device of claim 15, wherein the at least one processor is further configured to determine the current use condition based on an event of a touch input or an event of a button input to the audio output device.

17. The audio output device of claim 15, wherein the at least one processor is further configured to determine the current use condition based on a remaining capacity of a battery of the audio output device.

18. The audio output device of claim 13,
wherein the audio output device comprises a master device and a slave device, and
wherein an output of the first audio signal is synchronized between the master device and the slave device through additional wireless link between the master device and the slave device.

19. The audio output device of claim 13, wherein the at least one processor is further configured to, when the first audio source device is selected, receive the first audio broadcast stream based on at least one of address information and clock information included in the information of the first audio source device.

20. The audio output device of claim 13, wherein the at least one processor is further configured to:
when receiving the first audio broadcast stream while receiving a basic audio signal from a first electronic device through the wireless link, generate a mixed audio signal by mixing the basic audio signal and the first audio signal; and
output the mixed audio signal.
